(19) United States
(12) Patent Application Publication
(10) Pub. No.: US 2012/0052316 A1
(43) Pub. Date: Mar. 1, 2012

(54) AQUEOUS POLYMER DISPERSION OBTAINABLE BY FREE-RADICALLY INITIATED EMULSION POLYMERIZATION IN THE PRESENCE OF A MOLECULAR WEIGHT REGULATOR COMPOSITION

(75) Inventors: Elitsa Evstatieva, Ludwigshafen (DE); Dirk Lawrenz, Hassloch (DE); Johannes Jan-Bessel Minderhoud, Schifferstadt (DE); Florian Garlichs, Neustadt (DE); Peter Bassler, Viernheim (DE); Jens Baldamus, Ludwigshafen (DE)

(73) Assignee: BASF SE, Ludwigshafen (DE)

(21) Appl. No.: 13/216,459

(22) Filed: Aug. 24, 2011

Related U.S. Application Data
(60) Provisional application No. 61/377,467, filed on Aug. 27, 2010.

(51) Int. Cl. B32B 29/00; C09D 155/02; B32B 33/00; C08F 236/12; C09J 125/10; C09J 155/02; C09D 125/10; C08F 236/10

(52) U.S. Cl. 428/514; 524/836; 524/828; 526/207; 428/511

(57) ABSTRACT

Described is an aqueous polymer dispersion comprising a chain growth addition polymer obtainable by free-radically initiated emulsion polymerization of ethylenically unsaturated, free-radically polymerizable monomers, wherein the polymerization of the monomers is effected in the presence of a certain molecular weight regulator composition. The molecular weight regulator composition comprises at least one mercaptoalkylcarboxylic ester of a C2- to C4-carboxylic acid and at least one oligomeric compound of the formula R¹—X-(A-S—)ₙ-A-Y—R², where R¹ and R² are each H or CH₃—(CH₂)₀₋₂—C(═O)—, X and Y are each an oxygen atom or a sulfur atom, A is a divalent C₁- to C₁₈-alkylene group and n is from 1 to 8. Also described is a process for preparing the aqueous polymer dispersion. The polymer dispersion is useful as a binder, an adhesive, a sizing agent for fibers, in the manufacture of coatings or in the manufacture of paper coating slips.

The present invention relates to an aqueous polymer dispersion comprising a chain growth addition polymer obtainable by free-radically initiated emulsion polymerization of ethylenically unsaturated, free-radically polymerizable monomers, wherein the polymerization of the monomers is effected in the presence of a certain molecular weight regulator composition. The invention also relates to a process for preparing the aqueous polymer dispersion and the use of the polymer dispersion as a binder, an adhesive, a sizing agent for fibers, in the manufacture of coatings or in the manufacture of paper coating slips.

Aqueous polymer dispersions obtainable by free-radically initiated emulsion polymerization of ethylenically unsaturated, free-radically polymerizable monomers have a variety of use destinations. Binders for paper coating slips, for instance, are known that are based on copolymers of vinylaromatic compounds such as, for example, styrene, aliphatic dienes such as, for example, 1,3-butadiene and ethylenically unsaturated acid such as, for example, acrylic acid or methacrylic acid, or based on styrene-acrylate copolymers. Chain transfer agents are used as molecular weight regulators to adjust the molecular weight of the chain growth addition polymers being prepared by free-radical polymerization to a molecular weight that is suitable for the particular use destination. Among the most effective and frequently used molecular weight regulators are alkyl mercaptans, i.e., alkanes substituted with a thiol group, for example tert-dodecyl mercaptan (TDMC). These compounds have the advantage of leading to good performance characteristics for paper coating compositions as well as regulating the molecular weight of polymers. There is a particular demand for polymeric binders with a high binding force and for paper coating slips comprising polymeric binders and having good surface strength, for example good dry pick resistance and good wet pick resistance. TDMC does meet these requirements, but has the disadvantage of an unpleasant odor. This can prove troublesome in manufacture as well as in the end product. Moreover, TDMC is unwelcome in some use destinations for product safety reasons. Alternative molecular weight regulators based on alkyl esters of mercaptoalkyl carboxylic acids are advantageous in odor over alkyl mercaptans, but are not entirely satisfactory in the performance characteristics, for example the dry pick resistance or the wet pick resistance of paper coated with a coating slip.

U.S. Pat. No. 5,354,800 describes a method of producing copolymer dispersions which are useful inter alia as binders in paper coating compositions. The method comprises subjecting conjugated diene monomer, a further ethylenically unsaturated monomer and also an ethylenically unsaturated carboxylic acid monomer to polymerization in the presence of a combination of a hydrophilic chain transfer agent and a hydrophobic chain transfer agent. Hydrophobic chain transfer agents mentioned include inter alia alkyl mercaptans and mercaptoalkyl esters of alkyl carboxylic acids. International patent application PCT/EP2010/051833 describes aqueous polymer dispersions prepared from vinylaromatic compound, conjugated aliphatic diene and ethylenically unsaturated acid in a polymerization in the presence of a mercaptoalkyl carboxylic ester of a C2- to C4-carboxylic acid, more particularly mercaptoethyl propionate, as molecular weight regulator.

Molecular weight regulators are typically used in very high purity in respect of sulfur-containing compounds in order that unforeseeable and undesired effects of the sulfur-containing compounds on the course of the emulsion polymerization and on the quality and product properties of the chain growth addition polymer formed may be minimized. Molecular weight regulators based on mercaptoalkyl carboxylic esters such as, for example, mercaptoethyl propionate have the disadvantage that purification is very costly and inconvenient. The reason is that, owing to the nature of the synthesis, not only low-boiling constituents (ethylene sulfide for example), middle boilers (mercaptoethanol for example) but also high-boiling constituents (for example, oligomeric and polymeric polyethylene sulfides and esters thereof) are generated side by side.

Mercaptoethyl propionate is obtainable for example by acid-catalyzed transesterification of propionic esters with mercaptoethanol or by acid-catalyzed azeotropic esterification of propionic acid with mercaptoethanol in the presence of organic solvents as entrainers to remove the water of reaction. The problem is that not only the mercaptoethanol used as alcohol component but also the mercaptoalkyl carboxylic ester product are not only thermally but also acid labile. As a result, oligomeric polyethylene sulfides are typically formed in the course of the synthesis.

Purifying the as-synthesized crude product, i.e., a mixture of mercaptoalkyl carboxylic ester and varying amounts of residues of the starting materials—mercaptoalkanol, alkylcarboxylic acid, the alkyl carboxylate used for transesterification—and also secondary components and reagents and solvents of the synthesis such as, for example, toluene, cyclohexane, hexane, heptane, xylene, oligomeric polyethylene sulfides and ethylene sulfides is possible in principle by distillation. However, separation is fairly costly and inconvenient on an industrial scale, since the thermal lability necessitates distillation at a low pressure (ideally <20 mbar) to gently remove the desired mercaptoalkyl ester (e.g., mercaptoethyl propionate by ca. 180° C. at 1 bar). Furthermore, the distillation requires a large number of separation stages to ensure removal of the middle boilers (e.g., mercaptoethanol and alkyl carboxylic acid). In addition, the energy input into the distillation pot has to be so gentle as not to bring about a decomposition of the high-boiling oligomeric polyethylene sulfides with the formation of low and middle boilers which recontaminate the desired mercaptoalkyl carboxylic ester product. For the reasons mentioned, it is generally necessary to perform a multiple distillation at greatly reduced pressure using a distillation plant having a large number of separation stages to obtain a pure product of value (purity >99.8%).

It is an object of the present invention to provide aqueous polymer dispersions having a molecular weight set by using a molecular weight regulator which are very simple and inexpensive to obtain, have an ideally neutral odor compared with dispersions obtained using alkyl mercaptans and shall have very good performance characteristics when used as a binder in paper coating slips, more particularly very good dry pick resistance and very good wet pick resistance.

We have found that, surprisingly, there is no need for costly and inconvenient purification of the mercaptoalkyl carboxylic ester in that the as-synthesized crude product—or a crude product concentrated by removal of just a proportion of the low boilers (e.g., hydrocarbons, ethylene sulfide)—provides a chain transfer agent performance which, based on the mercaptoalkyl carboxylic ester content, is equivalent and actually even improved pick resistance properties when the chain growth addition polymer is used as a binder in paper coating slips.

The stated object is accordingly achieved according to the present invention by an aqueous polymer dispersion comprising a chain growth addition polymer obtainable by free-radically initiated emulsion polymerization of one or more ethylenically unsaturated, free-radically polymerizable monomers, wherein the polymerization of the monomers is effected in the presence of a molecular weight regulator composition, and wherein the molecular weight regulator composition comprises

(a) at least one mercaptoalkyl carboxylic ester of a C2- to C4-carboxylic acid, and
(b) at least one oligomeric compound of the formula

R¹—X-(A-S—)ₙ-A-Y—R²

where
R¹ and R² are independently the same or different, each being H or CH₃—(CH₂)ₘ—C(═O)—,
X and Y are independently the same or different, each being an oxygen atom or a sulfur atom,
A is a divalent C₁- to C₁₈-alkylene group,
n is from 1 to 8 and m is from 0 to 2.

To modify the properties of the polymers, the emulsion polymerization is carried out in the presence of at least one polymerization regulator. Here it is preferable to use substantially no alkylmercaptan, i.e., alkylmercaptans are not used at all or at any rate not in amounts affecting the odor characteristics of the polymer dispersion.

At least one molecular weight regulator composition is used, this composition comprising at least one mercaptoalkyl carboxylic ester of a C2- to C4-carboxylic acid as main constituent (a). The underlying carboxylic acids are acetic acid, propanoic acid, isobutanoic acid or n-butanoic acid, preferably propanoic acid. The mercaptoalkyl groups may comprise linear, branched or cyclic hydrocarbyl radicals having at least one SH group and, for example, up to 18 carbon atoms. Preference is given to compounds of the formula

R1-C(═O)—O—R2-SH

where R1 is an alkyl group of 1 to 3 carbon atoms and R2 is a divalent alkylene group of 1 to 18 carbon atoms. Particular preference is given to using 2-mercaptoethyl propionate as main component of the molecular weight regulator composition. The mercaptoalkyl carboxylic esters (a) are preferably present in the molecular weight regulator composition at 60% to 95% by weight or 65% to 90% by weight or 70% to 85% by weight.

The molecular weight regulator composition comprises, as a further constituent (b), at least one oligomeric compound of the formula

R¹—X-(A-S—)ₙ-A-Y—R²

where
R¹ and R² are independently the same or different, each being H or CH₃—(CH₂)ₘ—C(═O)—,
X and Y are independently the same or different, each being an oxygen atom or a sulfur atom,
A is a divalent C₁- to C₁₈-alkylene group,
n is from 1 to 8 and m is from 0 to 2.

Oligomeric compounds (b) of the formula

R¹—X—(CH₂—CH₂—S—)ₙ—CH₂—CH₂—Y—R²

where R¹ and R² are independently the same or different, each being H or CH₃—CH₂—C(═O)—,
X and Y are independently the same or different, each being an oxygen atom or a sulfur atom, and n is from 1 to 8, are preferred, particularly when 2-mercaptoethyl propionate is used as main component of the molecular weight regulator composition.

The oligomeric compounds (b) are preferably present in the molecular weight regulator composition at 1% to 20% by weight or at 1.5% to 10% by weight or at 2% to 5% by weight.

The molecular weight regulator composition by way of further constituents preferably additionally comprises small amounts of mercaptoethanol (particularly 2-mercaptoethanol) and/or ethylene sulfide. Mercaptoethanol may for example be present in the molecular weight regulator composition at 0.1% to 10% by weight or at 0.2% to 5% by weight or at 0.3% to 1% by weight. Ethylene sulfide may for example be present in the molecular weight regulator composition at 0.05% to 5% by weight or at 0.1% to 2% by weight or at 0.15% to 1% by weight.

The molecular weight regulator composition may further comprise non-sulfur-containing constituents, for example propionic acid in an amount of for example 0.1% to 10% by weight or 0.2% to 5% by weight or 0.3% to 1% by weight; organic solvents, more particularly aliphatic or aromatic hydrocarbons having 6 to 8 carbon atoms and an atmospheric boiling point of 80 to 140° C., for example in an amount of 1% to 20% by weight or 1.5% to 10% by weight or 2% to 5% by weight.

One embodiment of the invention is for example an aqueous polymer dispersion wherein the molecular weight regulator composition comprises

(a) 60% to 95% by weight of the mercaptoalkyl carboxylic ester and
(b) 1% to 20% by weight of the oligomeric compound.

One embodiment of the invention is also for example an aqueous polymer dispersion wherein the molecular weight regulator composition comprises

(a) 60% to 95% by weight of the mercaptoalkyl carboxylic ester,
(b) 1% to 20% by weight of the oligomeric compound,
(c) 0.1% to 10% by weight of mercaptoethanol, and
(d) 0.05% to 5% by weight of ethylene sulfide.

Further polymerization regulators can be used in addition, but are not absolutely necessary. Examples of further polymerization regulators which can optionally be used are organic compounds comprising sulfur in bound form such as thiodiglycol, ethylthioethanol, di-n-butyl sulfide, di-n-octyl sulfide, diphenyl sulfide, diisopropyl disulfide, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea. Further polymerization regulators are aldehydes such as formaldehyde, acetaldehyde and propionaldehyde, organic acids such as formic acid, sodium formate or ammonium formate, alcohols such as, in particular, isopropanol and also phosphorus compounds such as sodium hypophosphite.

The amount of all the molecular weight regulators is for example in the range from 0.01% to 5% and preferably in the range from 0.1% to 1% by weight, based on the monomers used in the polymerization. The regulators are preferably added together with the monomers. However, they may also be wholly or partly present in the initial charge. They can also be added in stages at different times than the monomers.

Ethylenically unsaturated, free-radically polymerizable monomers are polymerized in the free-radically initiated emulsion polymerization. Examples of suitable monomers are vinylaromatic compounds, conjugated aliphatic dienes, ethylenically unsaturated acids, ethylenically unsaturated carboxamides, ethylenically unsaturated carbonitriles, vinyl esters of saturated C₁- to C₂₀-carboxylic acids, esters of acrylic acid or methacrylic acid with monohydric C₁- to C₂₀-alcohols, allyl esters of saturated carboxylic acids, vinyl ethers, vinyl ketones, dialkyl esters of ethylenically unsaturated dicarboxylic acids, N-vinylpyrrolidone, N-vinylpyrrolidine, N-vinylformamide, N,N-dialkylaminoalkylacrylamides, N,N-dialkylaminoalkylmethacrylamides, N,N-dialkylaminoalkyl acrylates, N,N-dialkylaminoalkyl methacrylates, vinyl halides, aliphatic hydrocarbons having 2 to 8 carbon atoms and one or two double bonds, or mixtures thereof.

The emulsion polymer consists of so-called main monomers, preferably to an extent of at least 40% by weight, more preferably to an extent of at least 60% by weight and even more preferably to an extent of at least 80% by weight. The main monomers are selected from C1-C20-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds, or mixtures thereof. Examples are alkyl (meth)acrylates with a C1-C10-alkyl radical, such as methyl methacrylate, methyl acrylate, n-butyl acrylate, ethyl acrylate and 2-ethylhexyl acrylate. Mixtures of alkyl (meth)acrylates are also suitable in particular. Vinyl esters of carboxylic acids having 1 to 20 carbon atoms are for example vinyl laurate, vinyl stearate, vinyl propionate, vinyl versatate and vinyl acetate. Useful vinylaromatic compounds include vinyl toluene, alpha-methylstyrene, p-methylstyrene, alpha-butylstyrene, 4-n-butylstyrene, 4-n-decylstyrene and preferably styrene. Examples of nitriles are acrylonitrile and methacrylonitrile. The vinyl halides are chlorine-, fluorine- or bromine-substituted ethylenically unsaturated compounds, preferably vinyl chloride and vinylidene chloride. Examples of vinyl ethers are vinyl methyl ether and vinyl isobutyl ether. Vinyl ethers of alcohols comprising 1 to 4 carbon atoms are preferred. As hydrocarbons having 2 to 8 carbon atoms and one or two olefinic double bonds there may be mentioned ethylene, propylene, butadiene, isoprene and chloroprene.

Preferred main monomers are C1-C10-alkyl (meth)acrylates and mixtures of the alkyl (meth)acrylates with vinylaromatics, more particularly styrene (also referred together as polyacrylate binders) or hydrocarbons having 2 double bonds, more particularly butadiene, or mixtures of such hydrocarbons with vinylaromatics, more particularly styrene (also referred together as polybutadiene binders). In polybutadiene binders, the weight ratio of butadiene to vinylaromatics (more particularly styrene) can be for example in the range from 10:90 to 90:10 and preferably in the range from 20:80 to 80:20. Polybutadiene binders are particularly preferred.

In addition to the main monomers, the polymer may comprise further monomers, for example monomers having carboxylic acid, sulfonic acid or phosphonic acid groups. Carboxylic acid groups are preferred. Examples are acrylic acid, methacrylic acid, itaconic acid, maleic acid or fumaric acid and aconitic acid. The proportion of ethylenically unsaturated acids in the emulsion polymer is generally below 5% by weight. Further monomers also include, for example, hydroxyl-containing monomers, more particularly C1-C10-hydroxyalkyl (meth)acrylates, or amides such as (meth)acrylamide.

In one embodiment of the invention, the chain growth addition polymer is constructed of butadiene or mixtures of butadiene and styrene to an extent of at least 60% by weight or of C1 to C20 alkyl (meth)acrylates or mixtures of C1 to C20 alkyl (meth)acrylates and styrene to an extent of at least 60% by weight.

One embodiment of the invention utilizes as monomers
(A1) 19.8 to 80 parts by weight, preferably 25 to 70 parts by weight, of at least one vinylaromatic compound,
(B1) 19.8 to 80 parts by weight, preferably 25 to 70 parts by weight, of at least one conjugated aliphatic diene,
(C1) 0.1 to 15 parts by weight of at least one ethylenically unsaturated acid and
(D1) 0 to 20 parts by weight, preferably 0.1 to 15 parts by weight, of at least one further monoethylenically unsaturated monomer other than the monomers (A1) to (C1),
   wherein the sum total of the parts by weight of the monomers (A1) to (D1) is 100.

One embodiment of the invention utilizes as monomers
(A2) 19.8 to 80 parts by weight, preferably 25 to 70 parts by weight, of at least one vinylaromatic compound,
(B2) 19.8 to 80 parts by weight, preferably 25 to 70 parts by weight, of at least one monomer selected from C1 to C18 alkyl esters of acrylic acid and C1 to C18 alkyl esters of methacrylic acid,
(C2) 0.1 to 15 parts by weight of at least one ethylenically unsaturated acid and
(D2) 0 to 20 parts by weight, preferably 0.1 to 15 parts by weight, of at least one further monoethylenically unsaturated monomer other than the monomers (A2) to (C2),
   wherein the sum total of the parts by weight of the monomers (A2) to (D2) is in each case 100.

Monomers useful for group (A1) or (A2) include vinylaromatic compounds, for example styrene, α-methylstyrene and/or vinyltoluene. Among this group of monomers, styrene is preferred. 100 parts by weight of the monomer mixtures used altogether in the polymerization comprise for example from 19.8 to 80 parts by weight and preferably from 25 to 70 parts by weight of at least one monomer of group (A1) or (A2).

Monomers of group (B1) are for example 1,3-butadiene, isoprene, 1,3-pentadiene, dimethyl-1,3-butadiene and cyclopentadiene. Of this group of monomers, 1,3-butadiene and/or isoprene is/are preferred. 100 parts by weight of the monomer mixtures used altogether in the emulsion polymerization comprise for example from 19.8 to 80 parts by weight, preferably from 25 to 70 parts by weight and more particularly from 25 to 60 parts by weight of at least one monomer of group (B1).

Monomers of group (C1) or (C2) are for example ethylenically unsaturated carboxylic acids, ethylenically unsaturated sulfonic acids and vinylphosphonic acid. Preferred ethylenically unsaturated carboxylic acids are α,β-monoethylenically unsaturated mono- and dicarboxylic acids having 3 to 6 carbon atoms in the molecule. Examples thereof are acrylic acid, methacrylic acid, itaconic acid, maleic acid, fumaric acid, crotonic acid, vinylacetic acid and vinyllactic acid. Useful ethylenically unsaturated sulfonic acids include for example vinylsulfonic acid, styrenesulfonic acid, acrylamidomethylpropanesulfonic acid, sulfopropyl acrylate and sulfopropyl methacrylate. Acrylic acid and methacrylic acid are particularly preferred, acrylic acid in particular.

The acid-functional monomers of group (C1) or (C2) can be used in the polymerization in the form of the free acids and also partially or completely neutralized with suitable bases. Preference is given to using aqueous sodium hydroxide solution, aqueous potassium hydroxide solution or ammonia as neutralizing agent. 100 parts by weight of the monomer mixtures used in the emulsion polymerization comprise for example from 0.1 to 15 parts by weight, preferably from 0.1 to 10 parts by weight or from 1 to 8 parts by weight of at least one monomer of group (C1) or (C2).

As monomers of group (B2) there may be used esters of acrylic acid and of methacrylic acid with monohydric C₁- to C₁₈-alcohols such as methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, pentyl acrylates, pentyl methacrylates, 2-ethylhexyl acrylate, 2-ethylhexyl methacrylate. 100 parts by weight of the monomer mixtures used altogether in the polymerization comprise for example from 19.8 to 80 parts by weight and preferably from 25 to 70 parts by weight of at least one monomer of group (B2).

Other monoethylenically unsaturated compounds are contemplated for use as monomers of group (D2). Examples thereof are ethylenically unsaturated carboxamides such as in particular acrylamide and methacrylamide, ethylenically unsaturated carbonitriles such as in particular acrylonitrile and methacrylonitrile, vinyl esters of saturated C₁- to C₁₈-carboxylic acids, preferably vinyl acetate, allyl esters of saturated carboxylic acids, vinyl ethers, vinyl ketones, dialkyl esters of ethylenically unsaturated dicarboxylic acids, N-vinylpyrrolidone, N-vinylpyrrolidine, N-vinylformamide, N,N-dialkylaminoalkylacrylamides, N,N-dialkylaminoalkylmethacrylamides, N,N-dialkylaminoalkyl acrylates, N,N-dialkylaminoalkyl methacrylates, vinyl chloride and vinylidene chloride. Monomers useful for group (D1) include the monomers of group (D2) and also esters of acrylic acid and of methacrylic acid with monohydric C₁- to C₁₈-alcohols such as methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, pentyl acrylates, pentyl methacrylates, 2-ethylhexyl acrylate, 2-ethylhexyl methacrylate. This group of monomers is optionally used to modify the polymers. 100 parts by weight of the monomer mixtures used in the emulsion polymerization comprise for example from 0 to 20 parts by weight or from 0.1 to 15 parts by weight and more particularly from 0.5 to 10 parts by weight of at least one monomer of group (D1) or (D2).

In one embodiment of the invention, the further monomers (D1) and (D2) are each used in amounts of 0.1-15 parts by weight; the vinylaromatic compound is selected from styrene, methylstyrene and their mixture; the conjugated aliphatic diene is selected from 1,3-butadiene, isoprene and their mixture; and the ethylenically unsaturated acid is selected from one or more compounds of the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropane-sulfonic acid, sulfopropyl acrylate, sulfopropyl methacrylate, vinylphosphonic acid and salts thereof.

The emulsion polymerization typically utilizes initiators that form free radicals under the reaction conditions. The initiators are used for example in amounts up to 2% by weight and preferably at least 0.9% by weight, for example in the range from 1.0% to 1.5% by weight, based on the monomers to be polymerized. Suitable polymerization initiators include, for example, peroxides, hydroperoxides, hydrogen peroxide, sodium persulfate, potassium persulfate, redox catalysts and azo compounds such as 2,2-azobis(4-methoxy-2,4-dimethylvaleronitrile), 2,2-azobis(2,4-dimethylvaleronitrile) and 2,2-azobis(2-amidinopropane) dihydrochloride. Examples of further suitable initiators are dibenzoyl peroxide, tert.-butyl perpivalate, tert.-butyl per-2-ethylhexanoate, di-tert-butyl peroxide, diamyl peroxide, dioctanoyl peroxide, didecanoyl peroxide, dilauroyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perbenzoate, tert-butyl hydroperoxide, azobisisobutyronitrile, 2,2″-azobis(2-methylbutyronitrile), 2,2″-azobis(2,4-dimethylvaleronitrile) and 2,2″-azobis(N,N″-dimethyleneisobutyroamidine) dihydrochloride. Initiators are preferably selected from the group consisting of peroxodisulfates, peroxosulfates, azo initiators, organic peroxides, organic hydroperoxides and hydrogen peroxide. Particular preference is given to using water-soluble initiators, for example sodium persulfate, potassium persulfate, ammonium persulfate, sodium peroxodisulfate, potassium peroxodisulfate and/or ammonium peroxodisulfate. The polymerization can also be initiated by means of high-energy rays such as electron beams or irradiation with UV light.

To avoid high levels of undesirable arylcyclohexenes, it will prove particularly advantageous to perform the emulsion polymerization in at least two stages, wherein the beginning of the addition of the monomeric vinylaromatic compound (A) takes place at a different time than the beginning of the addition of the monomeric conjugated aliphatic diene. Preferably, at least a portion of the monomeric vinylaromatic compounds, for example at least 3.5% by weight of the total amount of all monomeric vinylaromatic compounds, is initially charged in the aqueous medium under polymerization conditions, or added to the polymerization mixture before the addition of monomeric conjugated aliphatic dienes is commenced.

The present invention also provides a process for preparing an aqueous polymer dispersion comprising one or more of the abovementioned ethylenically unsaturated, free-radically polymerizable monomers being polymerized by free-radically initiated emulsion polymerization in the presence of the above-described molecular weight regulator composition.

To augment the dispersal of the monomers in the aqueous medium, the protective colloids and/or emulsifiers customarily used as dispersants can be used. A detailed description of suitable protective colloids is given in Houben-Weyl, Methoden der organischen Chemie, volume XIV/1, Makromolekulare Stoffe, Georg-Thieme-Verlag, Stuttgart, 1961, pages 411 to 420. Suitable emulsifiers include surface-active substances whose number average molecular weight is typically below 2000 g/mol or preferably below 1500 g/mol, while the number average molecular weight of the protective colloids is above 2000 g/mol, for example in the range from 2000 to 100 000 g/mol and more particularly in the range from 5000 to 50 000 g/mol. Suitable emulsifiers include, for example, ethoxylated C8-C36 fatty alcohols having a degree of ethoxylation in the range from 3 to 50, ethoxylated mono-, di- and tri-C4-C12-alkylphenols having a degree of ethoxylation in the range from 3 to 50, alkali metal salts of dialkyl esters of sulfosuccinic acid, alkali metal and ammonium salts of C8-C12 alkyl sulfates, alkali metal and ammonium salts of C12-C18 alkylsulfonic acids and alkali metal and ammonium salts of C9-C18 alkylarylsulfonic acids. Cation-active emulsifiers are, for example, compounds having at least one amino or ammonium group and at least one C8-C22 alkyl group. When emulsifiers and/or protective colloids are used as auxiliaries to disperse the monomers, the amounts used thereof are for example in the range from 0.1% to 5% by weight, based on the monomers.

Useful protective colloids include for example degraded starch, more particularly maltodextrin. Useful starting starches for preparing degraded starches include all native starches such as starches from maize (corn), wheat, oats, barley, rice, millet, potato, peas, tapioca, sorghum or sago. Also of interest are those natural starches which have a high amylopectin content such as wax maize starch and wax potato starch. The amylopectin content of these starches is above 90%, usually in the range from 95 to 100%. Starches modified chemically by etherification or esterification can also be used for preparing the polymer dispersions of the present invention. Such products are known and commercially available. They are prepared for example by esterification of native starch or degraded native starch with inorganic or organic acids, their anhydrides or chlorides. Of particular interest are phosphated and acetylated degraded starches. The most common method to etherify starches consists in treating starch with organic halogen compounds, epoxides or sulfates in aqueous alkaline solution. Known starch ethers are alkyl ethers, hydroxyalkyl ethers, carboxyalkyl ethers and allyl ethers. The reaction products of starches with 2,3-epoxypropyltrimethylammonium chloride are also useful. Particular preference is given to degraded native starches, more particularly native starches degraded to maltodextrin. Further suitable starches include cationically modified starches, i.e., starch compounds having amino groups or ammonium groups. The degraded starches have for example an intrinsic viscosity ηi of less than 0.07 dl/g or less than 0.05 dl/g. The intrinsic viscosity ηi of the degraded starches is preferably in the range from 0.02 to 0.06 dl/g. The intrinsic viscosity ηi is determined in accordance with DIN EN1628 at a temperature of 23° C.

In one embodiment of the invention, the emulsion polymerization is effected in the presence of seed particles. The initial charge then comprises polymer seed, more particularly a polystyrene seed, i.e., an aqueous dispersion of finely divided polymer, preferably polystyrene, having a particle diameter of 20 to 40 nm.

The emulsion polymerization takes place in an aqueous medium. The aqueous medium may comprise for example completely ion-free water or else mixtures of water and a miscible solvent such as methanol, ethanol or tetrahydrofuran. As soon as the particular polymerization temperature desired is reached or within the time span of 1 to 15 minutes, preferably 5 to 15 minutes after reaching the polymerization temperature, the metered addition of the monomers is commenced. They can be for example pumped into the reactor continuously within for example 60 minutes to 10 hours, usually within 2 to 4 hours. The reaction mixture is preferably heated in the initial charge to the temperature required for the polymerization to proceed. These temperatures are for example in the range from 80 to 130° C., preferably 85 to 120° C. The polymerization can also be performed under pressure, e.g., at pressures up to 15 bar, e.g., at 2 to 10 bar. Adding the monomer can take place as a batch process, continuously or in stages.

After the polymerization has ended, further initiator may optionally be added to the reaction mixture and a postpolymerization performed at the same temperature as the main polymerization or else at a lower or higher temperature. To complete the polymerization reaction, it will in most cases suffice to stir the reaction mixture at the polymerization temperature for example 1 to 3 hours after addition of all the monomers. The pH in the polymerization can be for example in the range from 1 to 5. After polymerization, the pH is adjusted to a value of between 6 and 7 for example. In the aqueous polymer dispersion obtained, the dispersed particles have an average particle diameter of preferably 80 to 200 nm. The average particle diameter of the polymer particles can be determined by dynamic light scattering on a 0.005% to 0.01% by weight aqueous polymer dispersion at 23° C. by means of an Autosizer IIC from Malvern Instruments, England. The reported data are all based on the cumulant z-average diameter of the measured autocorrelation function as per ISO standard 13321.

In one embodiment, the solids content of the aqueous polymer dispersion of the present invention is in the range from 40% to 60% by weight. The solids content can be effected for example through appropriate adjustment of the water quantity and/or of the monomer quantities used in the emulsion polymerization.

The aqueous polymer dispersions of the present invention can be used as a binder, an adhesive, a sizing agent for fibers, in the manufacture of coatings or in the manufacture of paper coating slips. The aqueous polymer dispersions of the present invention are useful both for sizing textile fibers and for sizing mineral fibers, more particularly glass fibers. Owing to their high adhesiveness, particularly when comonomers are used that lead to a low glass transition temperature for the copolymer (below 20° C. for example), they can also be used as an adhesive and in the manufacture of coatings. The aqueous polymer dispersions of the present invention are preferably used as binders in paper coating slips and as binders for fibers, more particularly textile fibers.

The present invention accordingly also provides a paper coating slip comprising
(i) inorganic pigments and
(ii) an above-described aqueous polymer dispersion obtainable according to the present invention
   and optionally further added substances.

Paper coating slips, in addition to water, generally comprise pigments, binders and auxiliaries for setting the requisite rheological properties, for example thickeners. The pigments are typically dispersed in water. The paper coating slip comprises pigments in an amount of preferably at least 80% by weight, for example 80% to 95% by weight or 80% to 90% by weight, based on the total solids content. White pigments are contemplated in particular. Suitable pigments include, for example, metal salt pigments such as, for example, calcium sulfate, calcium aluminate sulfate, barium sulfate, magnesium carbonate and calcium carbonate, of which carbonate pigments, more particularly calcium carbonate are preferred. The calcium carbonate may be natural ground calcium carbonate (GCC), precipitated calcium carbonate (PCC), lime or chalk. Suitable calcium carbonate pigments are available for example as Covercarb® 60, Hydrocarb® 60 or Hydrocarb® 90 ME. Further suitable pigments include, for example, silicas, aluminas, aluminum hydrate, silicates, titanium dioxide, zinc oxide, kaolin, argillaceous earths, talc or silicon dioxide. Suitable further pigments are available for example as Capim® MP 50 (Clay), Hydragloss® 90 (Clay) or Talcum C10.

The paper coating slip comprises at least one binder. The polymer dispersion prepared according to the present invention can be used in the paper coating slip as sole binder or in combination with further binders. The most important functions of binders in paper coating slips are to bind the pigments to the paper and the pigments to each other and to some extent fill voids between pigment particles. For every 100 parts by weight of pigments, the amount of organic binder used (in terms of binder solids, i.e. without water or other solvent liquid at 21° C., 1 bar) is for example in the range from 1 to 50 parts by weight, preferably in the range from 1 to 25 parts by weight or in the range from 5 to 20 parts by weight.

Useful further binders include natural-based binders, more particularly binders based on starch, and also synthetic binders other than the polymers prepared according to the present invention, more particularly emulsion polymers obtainable by emulsion polymerization. Chain growth addition polymers prepared according to the present invention are preferably present as the sole synthetic binder. A binder based on starch is in this context to be understood as referring to any native, modified or degraded starch. Native starches can consist of amylose, amylopectin or mixtures thereof. Modified starches may comprise oxidized starch, starch esters or starch ethers. Hydrolysis can be used to reduce the molecular weight of the starch (degraded starch). Possible degradation products include oligosaccharides or dextrins. Preferred starches are cereal starch, maize starch and potato starch. Particular preference is given to cereal starch and maize starch and very particular preference is given to cereal starch.

Paper coating slips of the present invention may additionally comprise further additives and auxiliary materials, for example fillers, co-binders and thickeners to further optimize viscosity and water retention, optical brighteners, dispersants, surfactants, lubricants (e.g., calcium stearate and waxes), neutralizing agents (e.g., NaOH or ammonium hydroxide) for pH adjustment, defoamers, deaerators, preservatives (biocides for example), flow control agents, dyes (soluble dyes in particular), etc. Useful thickeners in addition to synthetic polymers (crosslinked polyacrylate for example) include particularly celluloses, preferably carboxymethylcellulose. Optical brighteners are, for example, fluorescent or phosphorescent dyes, particularly stilbenes.

The paper coating slip of the present invention preferably comprises an aqueous paper coating slip; water is present therein particularly due to the make-up form of the constituents (aqueous polymer dispersions, aqueous pigment slurries); the desired viscosity can be set by adding further water. Customary solids contents of paper coating slips range from 30% to 70% by weight. The pH of the paper coating slip is preferably adjusted to values in the range from 6 to 10, more particularly in the range from 7 to 9.5.

One embodiment of the invention relates to a paper coating slip wherein the polymers of the aqueous polymer dispersion prepared according to the invention are used in an amount of 1 to 50 parts by weight, based on the total amount of pigments, and wherein the pigments are present in an amount of 80 to 95 parts by weight, based on the total solids content and are selected from the group consisting of calcium sulfate, calcium aluminate sulfate, barium sulfate, magnesium carbonate, calcium carbonate, silicas, aluminas, aluminum hydrate, silicates, titanium dioxide, zinc oxide, kaolin, argillaceous earth, talc and silicon dioxide, and wherein the paper coating slip further comprises at least one auxiliary selected from the group consisting of thickeners, further polymeric binders, co-binders, optical brighteners, fillers, flow control agents, dispersants, surfactants, lubricants, neutralizing agents, defoamers, deaerators, preservatives and dyes.

The invention also provides paper or card coated with a paper coating slip of the present invention and also a process for coating paper or card, which comprises
preparing or providing an aqueous polymer dispersion according to the invention; and
using this polymer dispersion, at least one pigment and optional further auxiliaries to prepare a paper coating slip; and applying the paper coating slip to at least one surface of paper or card.

The paper coating slip is preferably applied to uncoated base papers or uncoated card. The amount is generally in the range from 1 to 50 g, and preferably in the range from 5 to 30 g (in terms of solids, i.e., without water or other solvent liquid at 21° C., 1 bar) per square meter. Coating can be effected by means of customary methods of application, for example via size press, film press, blade coater, air brush, doctor blade, curtain coating or spray coater. Depending on the pigment system, the aqueous dispersions of the water-soluble copolymers can be used in paper coating slips for the basecoat and/or for the topcoat.

Polymer dispersions according to the present invention are inexpensive to produce, since there is no need for costly and inconvenient purification of the mercaptoalkyl carboxylic ester. Compared with dispersions produced in accordance with the prior art using tert-dodecyl mercaptan as chain transfer agent, the odor and level of volatiles in the gas phase above the final dispersion is distinctly lower (not more than 5 ppm of mercaptoethyl propionate for example). Paper coating slips according to the present invention also have good performance characteristics. They have good run ability in paper coating processes and a high binding force. The coated papers and cards have good surface strength, more particularly very high wet and dry pick resistance. They are readily printable in the customary printing processes, such as relief printing, gravure, offset, digital, inkjet, flexographic, newsprint, letterpress, sublimation printing, laser printing, electrophotographic printing or a combination thereof.

### EXAMPLES

Unless the context suggests otherwise, percentages are always by weight. A reported content is based on the content in aqueous solution or dispersion.

Solids contents are determined by drying a defined amount of the particular aqueous polymer dispersion (about 5 g) at 140° C. in a drying cabinet to constant weight. Two separate measurements are carried out in each case and averaged. Glass transition temperature is determined in accordance with DIN 53765 using a TA8000 series DSC820 instrument from Mettler-Toledo Int. Inc.

The average particle diameters of the polymer particles are determined by dynamic light scattering on a 0.005% to 0.01% by weight aqueous polymer dispersion at 23° C. by means of an Autosizer IIC from Malvern Instruments, England. The cumulant z-average diameter of the measured autocorrelation function (ISO standard 13321) is reported.

### Examples 1-3

### Styrene-Butadiene Copolymer Dispersions

### Example 1 (Comparative Example)

### Tert-Dodecyl Mercaptan as Molecular Weight Regulator

A 200 liter pressure reactor equipped with an MIG stirrer and 3 metering devices is initially charged, at room temperature and under nitrogen, with 29 kg of deionized water, 2.2 kg of polystyrene latex (30 nm) and 5% by weight each of feeds 1A and 1B. Next the reactor contents are heated to 90° C. with stirring (180 rpm) and, when 85° C. is reached, 1 kg of a 7% by weight aqueous sodium persulfate solution is added. After 10 minutes, the metered addition is commenced, at the same time, of the remainders (95% in each case) of feed 1A and feed 1B, and of feed 2, and continued at uniform flow rates for 360 minutes in the case of the remainders of feeds 1A and 1B and for 390 minutes in the case of feed 2. Throughout the entire metering time, the streams of feed 1A and feed 1B are homogenized shortly before entry into the reactor. Thereafter, the reactor contents are left to postreact at 90° C. for a further 2 hours. Thereafter, the reactor contents are cooled down to room temperature and adjusted to pH 6.5 with 15% by weight aqueous NaOH solution, and the pressurized container is let down to atmospheric pressure.

Feed 1A, homogeneous mixture of

| | |
|---|---|
| 22.9 kg | of deionized water |
| 5.4 kg | of 15% by weight aqueous sodium dodecylsulfate solution |
| 3 kg | of acrylic acid |
| 0.52 kg | of 15% by weight aqueous sodium hydroxide solution |

Feed 1B, homogeneous mixture of

| | |
|---|---|
| 56.07 kg | of styrene |
| 0.8 kg | of tertiary-dodecyl mercaptan |
| 26.65 kg | of butadiene |

Feed 2

| | |
|---|---|
| 27.34 kg | of 3.5% by weight aqueous sodium persulfate solution |

The resulting aqueous dispersion (D1) had a solids content of 49% by weight, based on the total weight of the aqueous dispersion. Glass transition temperature was determined as 17° C. and particle size as 160 nm. Gel content 75%

### Example 2 (Comparative Example)

### High Purity Mercaptoethyl Propionate as Molecular Weight Regulator

Example 1 is repeated except that feed 1B has the following composition:

Feed 1B, homogeneous mixture of

| | |
|---|---|
| 56.07 kg | of styrene |
| 0.31 kg | of mercaptoethyl propionate (99.5% pure) |
| 26.65 kg | of butadiene |

The resulting aqueous dispersion (D2) had a solids content of 49.5% by weight, based on the total weight of the aqueous dispersion. Glass transition temperature was determined as 16° C. and particle size as 158 nm. Gel content 75%

### Example 3

Example 1 is repeated except that feed 1B has the following composition

Feed 1B, homogeneous mixture of

| | |
|---|---|
| 56.07 kg | of styrene |
| 0.41 kg | of molecular weight regulator composition comprising |
| | mercaptoethyl propionate (74 parts by weight) |
| | oligomeric polyethylene sulfides (10 parts by weight) |
| | mercaptoethanol (1 part by weight) |
| | ethylene sulfide (0.5 part by weight) |
| | toluene (13.5 parts by weight) |
| 26.65 kg | of butadiene |

The resulting aqueous dispersion (D3) had a solids content of 49.4% by weight, based on the total weight of the aqueous dispersion. Glass transition temperature was determined as 18° C. and particle size as 157 nm. Gel content 74%

Aqueous polymer dispersions D1 to D7, prepared according to the examples, are used as binders for paper coating slips.

### Paper Coating Slip Preparation:

The coating slip is prepared in a stirred assembly into which the individual components are fed in succession. The pigments are added in pre-dispersed form (as a slurry). The other components are added after the pigments, the order corresponding to the order in the reported coating slip formulation. Final solids content is set by adding water.

### Coating Slip Formulation:

70 parts of finely divided carbonate (Hydrocarb 90, Omya)
30 parts of finely divided clay (Hydragloss 90, Omya)
10 parts of coating slip binder (emulsion polymers of Examples 1-7)
0.5 part of rheology modifier (carboxymethylcellulose)

The coating slip is applied to one side of uncoated base paper using a semi-commercial coating machine, and dried via IR radiator. The weight of the coat applied is about 10 g/m².

The coated paper was tested for surface strength using test methods known to a person skilled in the art. The following test methods were used:

IGT dry pick resistance
IGT wet pick resistance
The results are summarized in Table 1.
Measurement of Dry Pick Resistance with IGT Test Printer (IGT Dry)

Strips were cut out of the in-test papers and printed with the IGT test printer. The printing inks used are specific test inks from Lorillieux, which transmit different tensile forces. The test strips are fed through the press at continuously increasing speed (maximum speed 200 cm/s). To evaluate the result, the point at which 10 picks have occurred on the paper surface after the start of printing is determined on the sample printing strip. The measure reported for dry pick resistance is the speed in cm/sec present at this point during printing and also the test ink used. The higher this printing speed at the tenth pick point, the better the quality rating of the paper surface.

Measurement of Wet Pick Resistance with IGT Test Printer (IGT Wet)

Strips were cut out of the in-test papers and printed with the IGT test printer. The printer was set up such that the test strips are moistened with water prior to the printing operation. The printing inks used are specific test inks from Lorilleux (No. 3807), which transmit different tensile forces. Printing is done at a constant speed of 0.6 cm/s. Picks out of the paper surface are visible as unprinted spots. To determine wet pick resistance, a color densitometer is used to determine color density in % compared with the full hue. The higher the reported color density, the better the wet pick resistance.

TABLE 1
results measured for dry and wet pick resistance

| | D1 | D2 | |
|---|---|---|---|
| | (comparator) | (comparator) | D3 |
| Top side dry pick resistance [cm/s] | 43 | 46 | 45 |
| Bottom side dry pick resistance [cm/s] | 46 | 48 | 53 |
| Top side wet pick resistance [%] | 72 | 72 | 77 |
| Bottom side wet pick resistance [%] | 76 | 79 | 86 |

### Odor Test

The coated papers were odor rated by a trained group of people. The procedure involved in odor tests of this kind is known to a person skilled in the art. The odor level of the samples was assessed on a scale from 1 to 6, where 1 denotes very good and 6 denotes very bad. The results are summarized in Table 2.

TABLE 2
results of odor test

| | Odor rating |
|---|---|
| Example 1 (tert-dodecyl mercaptan) | 4 |
| Example 2 (high purity mercaptoethyl propionate) | 3 |
| Example 3 (74% purity mercaptoethyl propionate) | 3 |

Example 3 exhibits significantly better wet pick resistance both on the top side and the bottom side of the coated paper and also significantly better dry pick resistance on the bottom side of the coated paper. The coated paper has an acceptable odor, this odor being better than that of a paper coated with Example 1.

### Examples 4-5

### Styrene-Butadiene-Acrylonitirile Copolymer Dispersions

### Example 4 (Comparative Example, Comprising Acrylonitrile)

### Tert-Dodecyl Mercaptan as Molecular Weight Regulator

A 200 liter pressure reactor equipped with an MIG stirrer and 3 metering devices is initially charged, at room temperature and under nitrogen, with 29 kg of deionized water, 2.1 kg of polystyrene latex (30 nm) and 5% by weight each of feeds 1A and 1B. Next the reactor contents are heated to 90° C. with stirring (180 rpm) and, when 85° C. is reached, 1 kg of a 7% by weight aqueous sodium persulfate solution is added. After 10 minutes, the metered addition is commenced, at the same time, of the remainders (95% in each case) of feed 1A and feed 1B, and of feed 2, and continued at uniform flow rates for 360 minutes in the case of the remainders of feeds 1A and 1B and for 390 minutes in the case of feed 2. Throughout the entire metering time, the streams of feed 1A and feed 1B are homogenized shortly before entry into the reactor. Thereafter, the reactor contents are left to postreact at 90° C. for a further 2 hours. Thereafter, the reactor contents are cooled down to room temperature and adjusted to pH 6.5 with 15% by weight aqueous NaOH solution, and the pressurized container is let down to atmospheric pressure.

Feed 1A, homogeneous mixture of

| | |
|---|---|
| 8.5 kg | of deionized water |
| 1.7 kg | of 15% by weight aqueous sodium dodecylsulfate solution |
| 2 kg | of acrylic acid |
| 0.48 kg | of 15% by weight aqueous sodium hydroxide solution |

Feed 1B, homogeneous mixture of

| | |
|---|---|
| 19.1 kg | of styrene |
| 0.72 kg | of tertiary-dodecyl mercaptan |
| 20.1 kg | of butadiene |
| 7.2 kg | of acrylonitrile |

Feed 2

| | |
|---|---|
| 10.7 kg | of 3.5% by weight aqueous sodium persulfate solution |

The resulting aqueous dispersion (D4) had a solids content of 48% by weight, based on the total weight of the aqueous dispersion. Glass transition temperature was determined as 8° C. and particle size as 160 nm. Gel content 77%

### Example 5

Example 4 is repeated except that feed 1B has the following composition:

Feed 1B, homogeneous mixture of

| 19.1 | kg | of styrene |
|---|---|---|
| 0.32 | kg | of molecular weight regulator composition comprising |
| | | mercaptoethyl propionate (74 parts by weight) |
| | | oligomeric polyethylene sulfides (10 parts by weight) |
| | | mercaptoethanol (1 part by weight) |
| | | ethylene sulfide (0.5 part by weight) |
| | | toluene (13.5 parts by weight) |
| 20 | kg | of butadiene |
| 7.2 | kg | of acrylonitrile |

The resulting aqueous dispersion (D5) had a solids content of 49.4% by weight, based on the total weight of the aqueous dispersion. Glass transition temperature was determined as 9° C. and particle size as 157 nm. Gel content 75%

The dry and wet pick resistance measurements and the results of the odor test are collated in Tables 3 and 4.

TABLE 3
results measured for dry and wet pick resistance

| | D4 (comparator) | D5 |
|---|---|---|
| Top side dry pick resistance [cm/s] | 49 | 51 |
| Bottom side dry pick resistance [cm/s] | 50 | 52 |
| Top side wet pick resistance [%] | 75 | 78 |
| Bottom side wet pick resistance [%] | 80 | 83 |

TABLE 4
results of odor test

| | Odor rating |
|---|---|
| Example 4 (tert-dodecyl mercaptan) | 5 |
| Example 5 (74% purity mercaptoethyl propionate) | 4 |

### Examples 6-7

### Styrene-Butadiene Copolymer Dispersions Prepared in the Presence of Degraded Starch

### Example 6 (Comparative Example)

### Tert-Dodecyl Mercaptan as Molecular Weight Regulator

A 200 liter pressure reactor equipped with an MIG stirrer and 3 metering devices is initially charged, at room temperature and under nitrogen, with 9.46 kg of deionized water, 2 kg of polystyrene latex (30 nm), 24 kg of degraded starch (50%) and 5% by weight each of feeds 1A and 1B. Next the reactor contents are heated to 90° C. with stirring (180 rpm) and, when 85° C. is reached, 0.9 kg of a 7% by weight aqueous sodium persulfate solution is added. After 10 minutes, the metered addition is commenced, at the same time, of the remainders (95% in each case) of feed 1A and feed 1B, and of feed 2, and continued at uniform flow rates for 360 minutes in the case of the remainders of feeds 1A and 1B and for 390 minutes in the case of feed 2. Throughout the entire metering time, the streams of feed 1A and feed 1B are homogenized shortly before entry into the reactor. Thereafter, the reactor contents are left to postreact at 90° C. for a further 2 hours. Thereafter, the reactor contents are cooled down to room temperature and adjusted to pH 6.5 with 15% by weight aqueous NaOH solution, and the pressurized container is let down to atmospheric pressure.

Feed 1A, homogeneous mixture of

| | |
|---|---|
| 15.5 kg | of deionized water |
| 1.4 kg | of 15% by weight aqueous sodium dodecylsulfate solution |
| 1.58 kg | of acrylic acid |
| 0.27 kg | of 15% by weight aqueous sodium hydroxide solution |

Feed 1B, homogeneous mixture of

| | |
|---|---|
| 22.5 kg | of styrene |
| 0.36 kg | of tertiary-dodecyl mercaptan |
| 15.4 kg | of butadiene |

Feed 2

| | |
|---|---|
| 6.3 kg | of 3.5% by weight aqueous sodium persulfate solution |

The resulting aqueous dispersion (D6) had a solids content of 50% by weight, based on the total weight of the aqueous dispersion. Glass transition temperature was determined as 18° C. and particle size as 165 nm. Gel content 79%

### Example 7

Example 6 is repeated except that feed 1B has the following composition:

Feed 1B, homogeneous mixture of

| | |
|---|---|
| 22.7 kg | of styrene |
| 0.18 kg | of molecular weight regulator composition comprising |
| | mercaptoethyl propionate (74 parts by weight) |
| | oligomeric polyethylene sulfides (10 parts by weight) |
| | mercaptoethanol (1 part by weight) |
| | ethylene sulfide (0.5 part by weight) |
| | toluene (13.5 parts by weight) |
| 15.4 kg | of butadiene |

The resulting aqueous dispersion (D7) had a solids content of 50.4% by weight, based on the total weight of the aqueous dispersion. Glass transition temperature was determined as 19° C. and particle size as 168 nm. Gel content 77%

The dry and wet pick resistance measurements and the results of the odor test are collated in Tables 5 and 6.

TABLE 5
results measured for dry and wet pick resistance

| | D6 (comparator) | D7 |
|---|---|---|
| Top side dry pick resistance [cm/s] | 45 | 45 |
| Bottom side dry pick resistance [cm/s] | 42 | 46 |
| Top side wet pick resistance [%] | 35 | 38 |
| Bottom side wet pick resistance [%] | 32 | 40 |

TABLE 6
results of odor test

| | Odor rating |
|---|---|
| Example 6 (tert-dodecyl mercaptan) | 3 |
| Example 7 (74% purity mercaptoethyl propionate) | 2 |

The examples with impure (74% purity) mercaptoethyl propionate generally have better wet pick resistance not only on the top side but also on the bottom side of the coated paper and also better dry pick resistance.

The papers coated with dispersions comprising impure (74% purity) mercaptoethyl propionate generally have better odor than papers coated with dispersions comprising tert-dodecyl mercaptan. Unexpectedly, there is no odor difference between papers based on pure or impure mercaptoethyl propionate despite the increased level of normally odor-intensive sulfides in the impure mercaptoethyl propionate.

We claim:

1. An aqueous polymer dispersion comprising a chain growth addition polymer obtainable by free-radically initiated emulsion polymerization of one or more ethylenically unsaturated, free-radically polymerizable monomers, wherein the polymerization of the monomers is effected in the presence of a molecular weight regulator composition, and wherein the molecular weight regulator composition comprises
(a) at least one mercaptoalkyl carboxylic ester of a C2- to C4-carboxylic acid, and
(b) at least one oligomeric compound of the formula
R¹—X-(A-S—)ₙ-A-Y—R²
where
R¹ and R² are independently the same or different, each being H or CH₃—(CH₂)ₘ—C(═O)—,
X and Y are independently the same or different, each being an oxygen atom or a sulfur atom,
A is a divalent C₁- to C₁₈-alkylene group,
n is from 1 to 8 and m is from 0 to 2.

2. The aqueous polymer dispersion according to the preceding claim wherein component (a) comprises 2-mercaptoethyl propionate and component (b) is at least one compound of the formula
R¹—X—(CH₂—CH₂—S—)ₙ—CH₂—CH₂—Y—R²
where
R¹ and R² are independently the same or different, each being H or CH₃—CH₂—C(═O)—,
X and Y are independently the same or different, each being an oxygen atom or a sulfur atom, and
n is from 1 to 8.

3. The aqueous polymer dispersion according to either of the preceding claims wherein the molecular weight regulator composition comprises a sulfur compound selected from mercaptoethanol, ethylene sulfide or their mixture as well as said components (a) and (b).

4. The aqueous polymer dispersion according to any preceding claim wherein the molecular weight regulator composition comprises
(a) 60% to 95% by weight of the mercaptoalkyl carboxylic ester and
(b) 1% to 20% by weight of the oligomeric compound.

5. The aqueous polymer dispersion according to any preceding claim wherein the molecular weight regulator composition comprises
(a) 60% to 95% by weight of the mercaptoalkyl carboxylic ester,
(b) 1% to 20% by weight of the oligomeric compound,
(c) 0.1% to 10% by weight of mercaptoethanol, and
(d) 0.05% to 5% by weight of ethylene sulfide.

6. The aqueous polymer dispersion according to any preceding claim wherein the ethylenically unsaturated, free-radically polymerizable monomers are selected from the group consisting of vinylaromatic compounds, conjugated aliphatic dienes, ethylenically unsaturated acids, ethylenically unsaturated carboxamides, ethylenically unsaturated carbonitriles, vinyl esters of saturated C₁- to C₂₀-carboxylic acids, esters of acrylic acid or methacrylic acid with monohydric C₁- to C₂₀-alcohols, allyl esters of saturated carboxylic acids, vinyl ethers, vinyl ketones, dialkyl esters of ethylenically unsaturated dicarboxylic acids, N-vinylpyrrolidone, N-vinylpyrrolidine, N-vinyl-formamide, N,N-dialkylaminoalkylacrylamides, N,N-dialkylaminoalkylmethacrylamides, N,N-dialkylaminoalkyl acrylates, N,N-dialkylaminoalkyl methacrylates, vinyl halides, aliphatic hydrocarbons having 2 to 8 carbon atoms and one or two double bonds, or mixtures thereof.

7. The aqueous polymer dispersion according to any preceding claim wherein the chain growth addition polymer is constructed of butadiene or mixtures of butadiene and styrene to an extent of at least 60% by weight or of C1 to C20 alkyl (meth)acrylates or mixtures of C1 to C20 alkyl (meth)acrylates and styrene to an extent of at least 60% by weight.

8. The aqueous polymer dispersion according to the preceding claim utilizing as monomers
(A1) 19.8 to 80 parts by weight of at least one vinylaromatic compound,
(B1) 19.8 to 80 parts by weight of at least one conjugated aliphatic diene,
(C1) 0.1 to 15 parts by weight of at least one ethylenically unsaturated acid and
(D1) 0 to 20 parts by weight of at least one further monoethylenically unsaturated monomer other than the monomers (A1) to (C1); or
(A2) 19.8 to 80 parts by weight of at least one vinylaromatic compound,
(B2) 19.8 to 80 parts by weight of at least one monomer selected from C1 to C18 alkyl esters of acrylic acid and C1 to C18 alkyl esters of methacrylic acid,
(C2) 0.1 to 15 parts by weight of at least one ethylenically unsaturated acid and
(D2) 0 to 20 parts by weight of at least one further monoethylenically unsaturated monomer other than the monomers (A2) to (C2),
wherein the sum total of the parts by weight of the monomers (A1) to (D1) or (A2) to (D2) is in each case 100.

9. The aqueous polymer dispersion according to the preceding claim wherein the further monomers (D1) and (D2) are each used in amounts of 0.1-15 parts by weight; the vinylaromatic compound is selected from styrene, methylstyrene and their mixture; the conjugated aliphatic diene is selected from 1,3-butadiene, isoprene and their mixture; and the ethylenically unsaturated acid is selected from one or more compounds of the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, vinylphosphonic acid and salts thereof.

10. The aqueous polymer dispersion according to either of the two preceding claims wherein the emulsion polymerization is effected in the presence of seed particles.

11. A process for preparing an aqueous polymer dispersion comprising one or more ethylenically unsaturated, free-radically polymerizable monomers being polymerized by free-radically initiated emulsion polymerization in the presence of a molecular weight regulator composition, wherein the molecular weight regulator composition includes the molecular weight regulator composition features according to any of claims 1 to 5.

12. The process according to the preceding claim wherein the ethylenically unsaturated, free-radically polymerizable monomers are selected from the group consisting of vinylaromatic compounds, conjugated aliphatic dienes, ethylenically unsaturated acids, ethylenically unsaturated carboxamides, ethylenically unsaturated carbonitriles, vinyl esters of saturated C₁- to C₂₀-carboxylic acids, esters of acrylic acid or methacrylic acid with monohydric C₁- to C₂₀-alcohols, allyl esters of saturated carboxylic acids, vinyl ethers, vinyl ketones, dialkyl esters of ethylenically unsaturated dicarboxylic acids, N-vinylpyrrolidone, N-vinylpyrrolidine, N-vinylformamide, N,N-dialkylaminoalkylacrylamides, N,N-dialkylaminoalkylmethacrylamides, N,N-dialkylaminoalkyl acrylates, N,N-dialkylaminoalkyl methacrylates, vinyl halides, aliphatic hydrocarbons having 2 to 8 carbon atoms and one or two double bonds, or mixtures thereof.

13. The process according to either of the two preceding claims wherein the polymer dispersion comprises a chain growth addition polymer constructed of butadiene or mixtures of butadiene and styrene to an extent of at least 60% by weight or of C1 to C20 alkyl (meth)acrylates or mixtures of C1 to C20 alkyl (meth)acrylates and styrene to an extent of at least 60% by weight.

14. The process according to any preceding process claim wherein the emulsion polymerization is effected in the presence of seed particles.

15. The process according to any preceding process claim utilizing
(A) 19.8 to 80 parts by weight of at least one vinylaromatic compound selected from the group consisting of styrene, methylstyrene and their mixture,
(B) 19.8 to 80 parts by weight of at least one conjugated aliphatic diene selected from the group consisting of 1,3-butadiene, isoprene and their mixture,
(C) 0.1 to 15 parts by weight of at least one ethylenically unsaturated acid selected from the group consisting of acrylic acid, methacrylic acid and salts thereof, and
(D) 0 to 20 parts by weight of at least one further monoethylenically unsaturated monomer other than the monomers (A) to (C) and selected from the group consisting of C1- to C18-alkyl esters of acrylic acid and C1- to C18-alkyl esters of methacrylic acid,
wherein the sum total of parts by weight of the monomers (A) to (D) is 100.

16. The use of the emulsion chain growth addition polymer of the aqueous polymer dispersion according to any of claims 1 to 10 as a binder, an adhesive, a sizing agent for fibers, in the manufacture of coatings or in the manufacture of paper coating slips.

17. A paper coating slip comprising
(i) inorganic pigments and
(ii) an aqueous polymer dispersion comprising an emulsion chain growth addition polymer according to any of claims 1 to 10.

18. Paper or card coated with a paper coating slip according to the preceding claim.
